(19) United States
(12) Patent Application Publication
(10) Pub. No.: US 2017/0248401 A1
(43) Pub. Date: Aug. 31, 2017

(54) METHODS AND SYSTEMS FOR TRACKING USAGE OF AN ITEM

(71) Applicant: IML TECHNOLOGIES, INC., Salt Lake City, UT (US)

(72) Inventors: Michael Osborne Isom, West Valley, UT (US); Duane Michael Scott Johnson, Cottonwood Heights, UT (US)

(21) Appl. No.: 15/443,803

(22) Filed: Feb. 27, 2017

Related U.S. Application Data
(60) Provisional application No. 62/300,475, filed on Feb. 26, 2016.

(51) Int. Cl. G01B 7/004; A61J 7/02; A61J 1/03; G08B 21/18

(52) U.S. Cl. CPC G01B 7/004; G08B 21/18; A61J 7/02; A61J 1/035

(57) ABSTRACT

Embodiments are directed to apparatuses, methods and systems for tracking usage of an item. In one scenario, a microcontroller is configured to send a periodic signal over electrical traces that are distributed over an item to determine whether a change in electrical throughput has occurred in a trace. Upon determining that such a change has occurred, an indication is generated that describes the type of usage that occurred and the time at which the use occurred. An indication of the type of usage and the time of occurrence is then provided to specified recipients. Apparatuses for tracking such usage include a battery, a microprocessor, a transmitter and capsules for storing the controlled substances. Each capsule has an electrical trace extending through at least some of the capsule. The microprocessor is configured to determine, using the electrical traces, which capsules have been opened by identifying which traces have been broken.

### CROSS-REFERENCE TO RELATED APPLICATIONS

This application claims priority to and the benefit of U.S. Provisional Patent Application Ser. No. 62/300475, entitled “Methods and Systems for Tracking Usage of an Item,” filed on Feb. 26, 2016, which application is incorporated by reference herein in its entirety.

### BACKGROUND

Many items that are produced are never opened. And many items that are produced for a certain individual are opened by the wrong individual. Still further, there is no way to track usage of a wide variety of products that are purchased and sold throughout the country. Providers of these goods may wish to know whether their goods end up being used and, if so, how they are used. Currently, there is no mechanism for tracking such use.

### BRIEF SUMMARY

Embodiments described herein are directed to apparatuses, methods and systems for tracking usage of an item. In one embodiment, a microcontroller is configured to send a periodic signal over one or more electrical traces that are distributed over an item to determine whether a change in electrical throughput has occurred in the trace. Upon determining that a change in electrical throughput has occurred, an indication is generated that describes the type of usage that occurred and the time at which the use occurred. The method then includes providing the indication of type of usage and the time of occurrence to one or more specified recipients.

In another embodiment, an apparatus is provided for tracking usage of controlled substances. The apparatus includes a battery, a microprocessor, a transmitter and capsules for storing the controlled substances. Each capsule has an electrical trace extending through at least a portion of the capsule. The microprocessor is configured to determine, using the electrical traces, which capsules have been opened by identifying which traces have been broken.

In another embodiment, a system for tracking usage of controlled substances is provided. The system includes an enclosure that provides protection and access to a storage apparatus that has controlled substances contained therein. The storage apparatus can be inserted into or removed from the enclosure. The enclosure includes a battery, a display, a transmitter and a microcontroller configured to control operation of the display and to further analyze trace signals to determine usage of the controlled substances. The storage apparatus includes capsules for storing the controlled substances, where each capsule has an electrical trace extending through at least a portion of the capsule. The microprocessor of the enclosure determines, using the electrical traces of the storage apparatus, which capsules have been opened by identifying which traces have been broken.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an architecture in which embodiments described herein may operate including tracking usage of an item.

FIG. 2A illustrates a front view of a pill tray embodiment which is configured to track pill usage.

FIG. 2B illustrates a back view of a pill tray embodiment which is configured to track pill usage.

FIG. 3A illustrates an exterior view of a pill tray case designed to hold a pill tray.

FIG. 3B illustrates an interior view of a pill tray case designed to hold a pill tray.

FIG. 3C illustrates an electronic display screen configured to display patient information and pill usage data.

FIG. 4 illustrates a front view of a pill tray embodiment which includes electrical contacts for communication with other components.

FIG. 5 illustrates a perspective view of multiple layers of a pill tray embodiment.

FIG. 6 illustrates an example prescription medication report for a patient showing prescription usage and compliance over time.

FIG. 7 illustrates an alternative prescription compliance chart, along with a visual showing which pills were punched from the pill tray.

FIG. 8 illustrates a flowchart of an example method for tracking usage of one or more items including prescription pills.

FIG. 9 illustrates a front view of a syringe tray embodiment which includes electrical contacts for communication with other components.

### DETAILED DESCRIPTION

Embodiments described herein are directed to apparatuses, methods and systems for tracking usage of an item. In one embodiment, a microcontroller is configured to send a periodic signal over one or more electrical traces that are distributed over an item to determine whether a change in electrical throughput has occurred in the trace. Upon determining that a change in electrical throughput has occurred, an indication is generated that describes the type of usage that occurred and the time at which the use occurred. The method then includes providing the indication of type of usage and the time of occurrence to one or more specified recipients.

In another embodiment, an apparatus is provided for tracking usage of controlled substances. The apparatus includes a battery, a microprocessor, a transmitter and capsules for storing the controlled substances. Each capsule has an electrical trace extending through at least a portion of the capsule. The microprocessor is configured to determine, using the electrical traces, which capsules have been opened by identifying which traces have been broken.

In another embodiment, a system for tracking usage of controlled substances is provided. The system includes an enclosure that provides protection and access to a storage apparatus that has controlled substances contained therein. The storage apparatus can be inserted into or removed from the enclosure. The enclosure includes a battery, a display, a transmitter and a microcontroller configured to control operation of the display and to further analyze trace signals to determine usage of the controlled substances. The storage apparatus includes capsules for storing the controlled substances, where each capsule has an electrical trace extending through at least a portion of the capsule. The microprocessor of the enclosure determines, using the electrical traces of the storage apparatus, which capsules have been opened by identifying which traces have been broken.

The embodiments described herein may implement various types of microprocessors, microcontrollers or computing systems. These computing systems are now increasingly taking a wide variety of forms. Computing systems may, for example, be mobile phones, electronic appliances, laptop computers, tablet computers, wearable devices, desktop computers, mainframes, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed by a microprocessor or on a computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in or may interface with a cloud computing system. Cloud computing systems may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

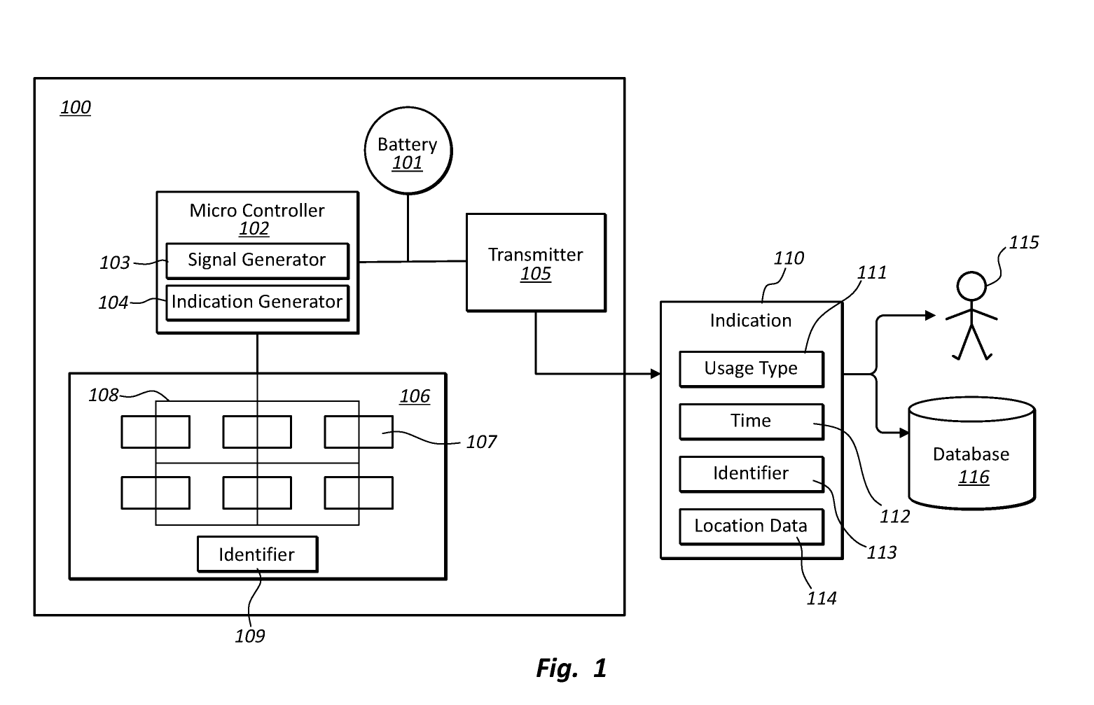

Referring to the figures, FIG. 1 illustrates a schematic diagram of an apparatus 100 for tracking usage of an item. The item may include substantially any item that can be used or consumed. To track the item, traces may be printed or otherwise placed over the item directly, or over capsules 107 or other containers that contain the item. The traces 108 are connected to a power source 101 and a microcontroller 102 or microprocessor. The microcontroller 102 can monitor power flow through each trace 108. The monitoring may be continuous, or may occur at specified intervals. For instance, the microcontroller 102 may poll the traces every minute (or every 10 minutes, etc.) to determine whether power is still being transmitted over the traces. Each trace may be individually tracked, or the traces may be tracked in regions or groups. Thus, at each polling period, the microcontroller 102 can determine which traces 108 have been broken, and thus which items have been used or consumed.

For example, if the traces 108 are placed or printed on a tray of pharmaceutical pills (e.g. tray 106), the traces may be broken when the pills are pushed out of their capsules 107. The broken traces 108 printed over the capsules no longer conduct electricity. In this manner, the microcontroller 102 can determine, at each polling period, which traces are still active, and which have been broken, thereby indicating which pills have been dispensed and which pills still remain in the tray. The microcontroller 102 can further determine when each pill was pushed out. For instance, if the microcontroller is continuously monitoring the state of the traces, it will know instantaneously which pill was dispensed and when it was dispensed. If the microcontroller 102 is monitoring the state of the traces every five minutes, it will know within five minutes which pills were dispensed.

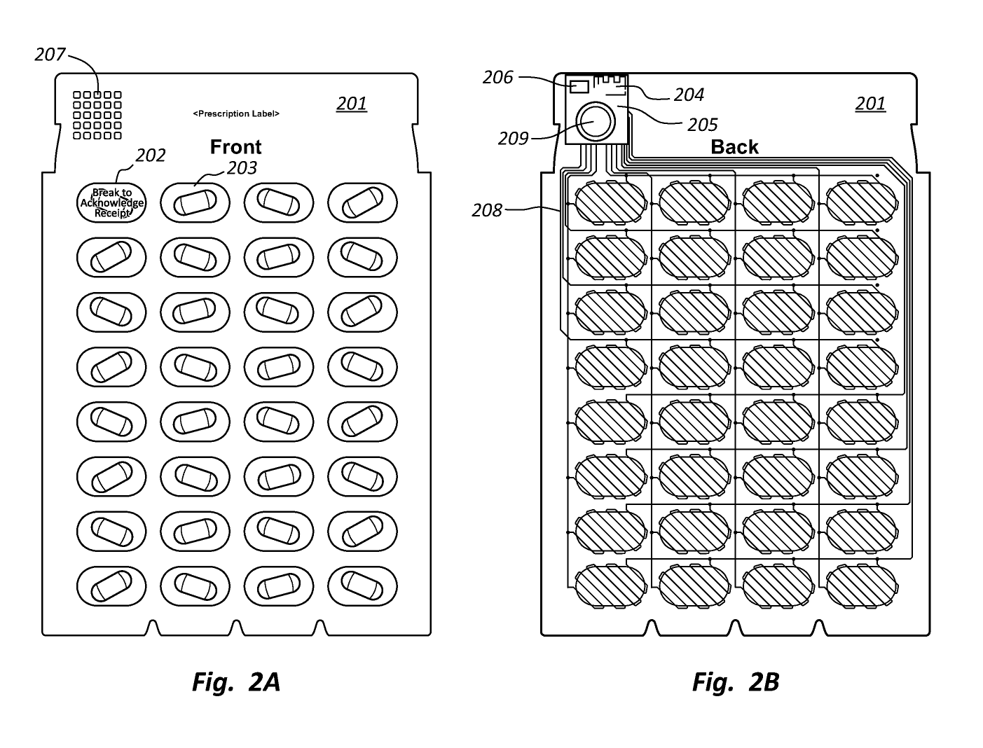

The microcontroller 102 may be connected to a single tray of pills, or may be connected to multiple different trays. Each tray 106 may have its own identifier 109. This identifier may be physically printed on the tray 106 and/or may be an electrical identifier that can be stored in a memory. This memory can be read by the microcontroller and, as such, the identity of the tray 106 can be determined. The signal generator 104 may generate trace signals continuously, or at a specified rate, when the signals from the generator travel through the traces 108, they may travel through or over each capsule 107 individually. Thus, if a capsule is punctured, even out of order, the microcontroller 102 will be able to determine which exact capsule was punctured and when. This will be explained further below with regard to FIG. 2A-4.

In some embodiments, the apparatus 100 of FIG. 1 may also include one or more transmitters, receivers or transceivers 105. These communication components may include hardware radios such as WiFi radios, GPS radios, Bluetooth radios, Cellular radios or other types of communication hardware. The radios 105 may be used to transfer data between the apparatus and outside computing systems (such as cloud data stores or other databases). The radios may also be used to determine the location of the apparatus. For example, at each polling, the microcontroller 102 may communicate with one or more of the radios 105 to determine the current location of the apparatus 100. Thus, information generated at each polling may include an indication of which traces 108 are broken and which are still connected, the time of the polling, and the location of the apparatus 100. Each of these pieces of information may be useful in determining how, where and when pharmaceuticals are consumed (or at least dispensed from packaging), and which pharmaceuticals were included in the apparatus.

The traces shown in the apparatus 100 of FIG. 1 may also be applied in other situations to track usage of an item. For example, traces may be printed on or otherwise applied to the seal of an envelope or other packaging item such as a box or sealed container. The packaging item may include an embedded battery, microcontroller, traces and/or a radio. The traces may be applied to the packaging item over one or more seals, such that upon opening of the seal, at least one of the trace connections is broken, and the packaging item is determined to have been opened. In this manner, companies could track which packages or envelopes are actually opened and which are not opened. Moreover, the apparatus could indicate when and where the packaging item was opened. Similar traces could be applied to pill bottles or other containers whose open or closed state is desirable to track.

At specified periods, the microcontroller 102 generates an indication 110 of the type of usage 111 that occurred and the time 112 it occurred. This indication 110 is then transmitted to one or more specified recipients (e.g. user 115 and/or database 116). The indication of usage may also include an indication of where the item was (e.g. in location data 114) when each usage occurred as well as provide an identifier 114 for the apparatus 100 and/or the identifier 109 of the pill tray. This indication may be sent at specified intervals, or at certain times. The indications may be stored in database 116. Database 116 may be a local database or a distributed data store such as a cloud database.

Determining that a change has occurred in the trace may include determining that electrical conductivity has changed in the trace. As shown in FIGS. 2A and 2B, each capsule 203 in the pill tray 201 is covered by a trace. Each trace 208 may have a separate electrical connection to the microcontroller 206. The electrical conductivity or the level of electrical signal reaching the microcontroller 206 may change due to the trace being bent or broken. For example, the microcontroller 206 may send a signal over the traces before any of that traces 208 have been punctured. That signal returns to the microcontroller to establish a base level signal. Then, when the traces are punctured, the signal returning to the microcontroller 206 will have a smaller value than the base level signal. Moreover, the design of the traces 208 provides an indication to the microcontroller 206 of where that trace was punctured and is no longer conducting electricity.

In some cases, the change in the trace may be temporary, and the trace may not facilitate conductivity for a period of time (such as if a container lid is open), and then may again facilitate conductivity at a later period in time (e.g. when the container lid is closed). In the case of a package of pills, such as that shown in FIGS. 2A, 2B and 4, the change in the trace will most often be a broken trace. This results in a loss of conductivity in the trace or an “open circuit.” In FIG. 2, the traces are shown as being placed over every capsule. Of course, it will be understood that the traces may be placed on every other capsule, or on a select subset or pattern of capsules. The battery 209 provides power for the microcontroller and for the transmitter 204, as well as the signals that are sent over the traces. It will be understood, of course, that a wired power source maybe alternatively used. In some cases, a receipt slot 202 may be used that, when broken, acknowledges receipt of the pill tray 201. Upon puncture of that receipt slot, the location and time are noted, as well as the tray's identifier.

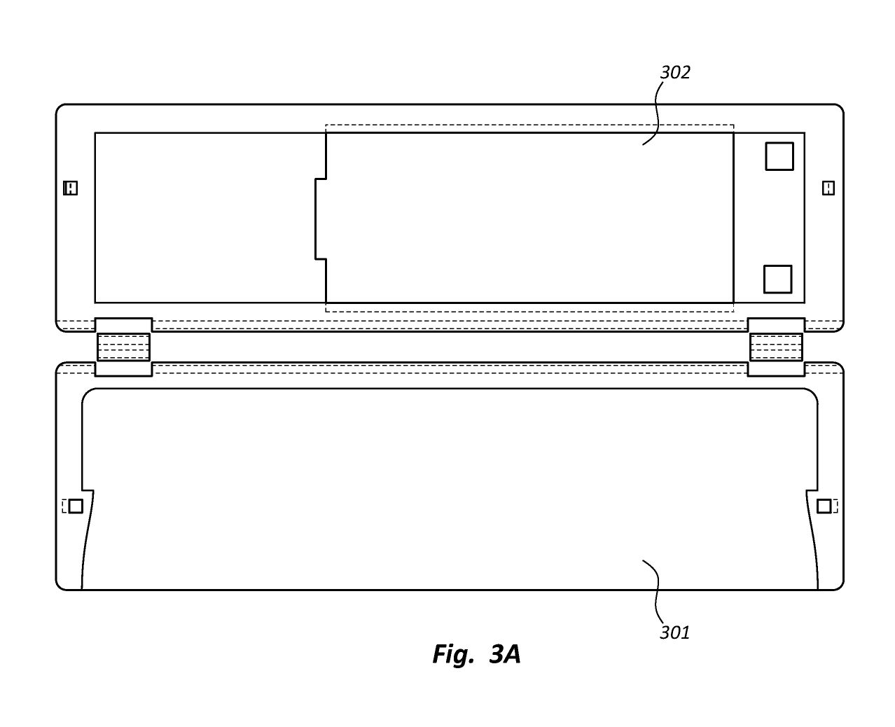

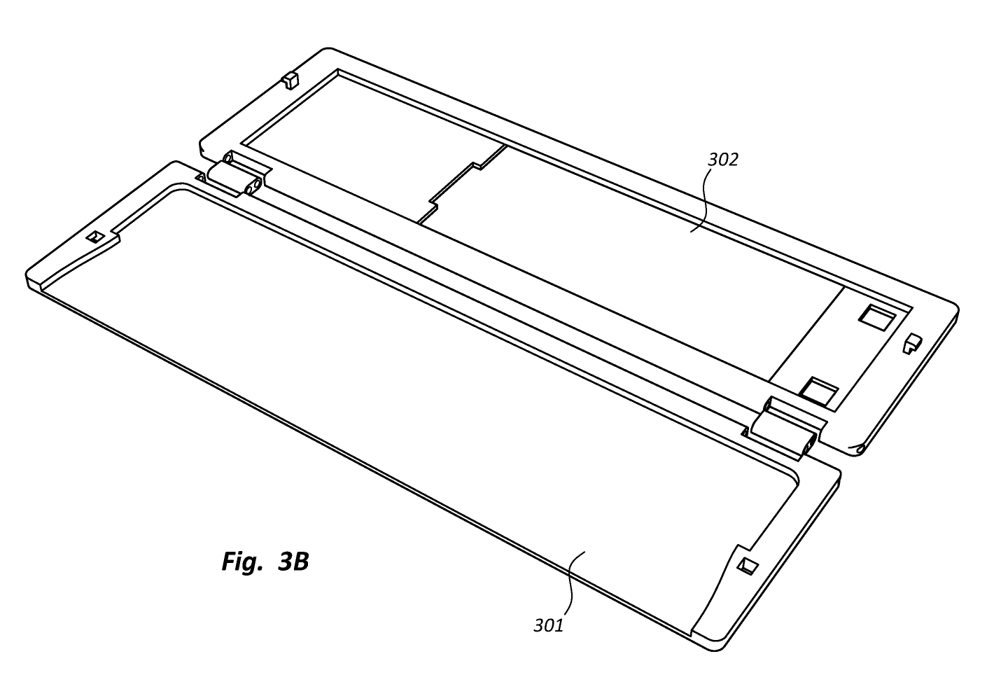

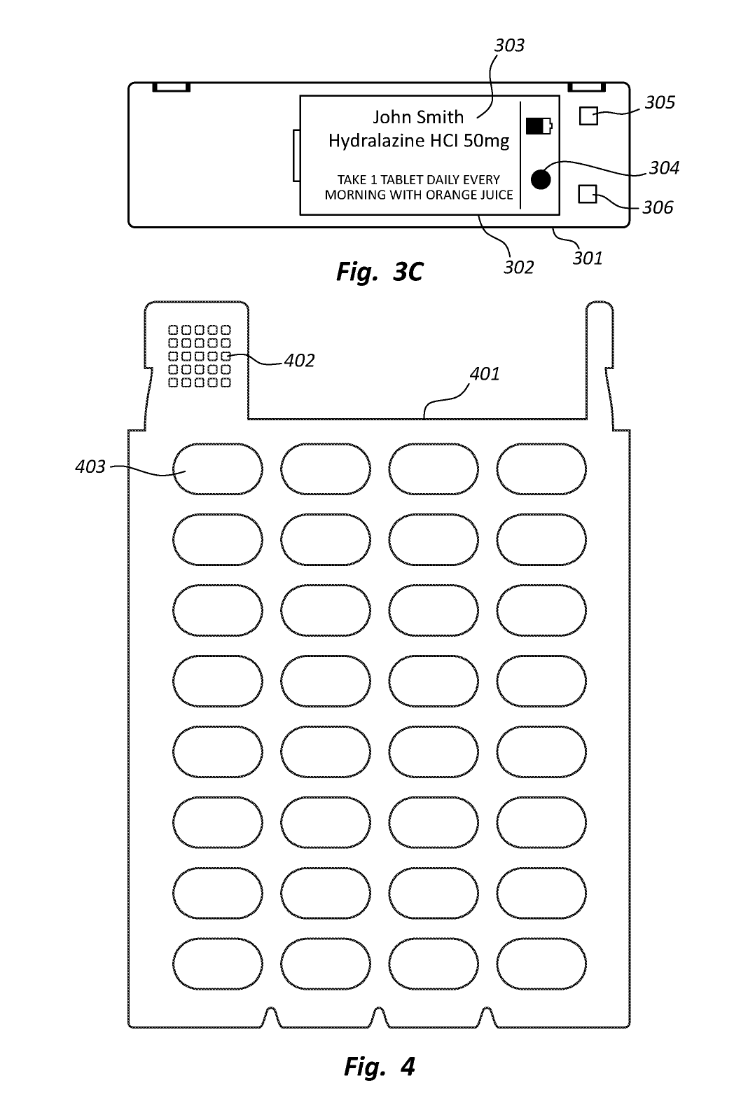

The pill tray 201 may be configured, to operate as a standalone device, or maybe contained within a container or case. As shown in FIG. 3A, a case 301 may be provided into which the pill tray 302 may be placed. FIG. 3A shows the back side of the pill tray, and FIG. 3B shows the front side of the pill tray. In some embodiments, the case 301 may include hardware components such as the battery, microprocessor, and transmitter while the pill tray includes only the traces and electrical contacts 207 for communicating with the microcontroller. Such an embodiment is shown in FIG. 4. The pill tray 401 of FIG. 4 includes capsules 403, traces (not shown, but would be present on the back side), and electrical contact pads 402. The electrical contact pads allow the pill tray 401 to be placed within electrical contact with a microcontroller simply by sliding the electrical contact pads 402 into position with corresponding electrical pads on the case. Alternatively, the pill tray may operate as a standalone device, having the battery, microcontroller, transmitter and other components built in to the tray.

In the pill tray 401, the pills are typically dispensed in order from top left to bottom right. As each pill is dispensed, the apparatus determines that a change has occurred in the traces—specifically that a trace has been broken. This results in a change in conductivity or a change in voltage across the trace. As these changes are registered, the apparatus can monitor the consumption of pills and can communicate to one or more entities that the pills are nearly out and need to be replenished. For example, if all but a few of the pills have been dispensed, the microcontroller may use a built-in radio to communicate that more pills are to be ordered. The communication may include a unique identifier for the type of pills in the package, and may further include a unique identifier for that package of pills. Thus, the reorder information may include an indication of when and where each pill was dispensed, and which exact package they were dispensed from.

The notifications generated by the apparatus may also be used to assist the user of the controlled substances. For example, as the pills are dispensed, the apparatus could be set to issue reminders through a software application (e.g. a smartphone application), to give a warning if a pill is not taken, to advise a health care provider or other identified user if a certain number of pills are taken in an inappropriate manner (e.g., overdose or potentially selling the pills, etc), or send an indication that a user has travelled without taking their pills with them. Other embodiments may also be implemented using the knowledge of where, when, and which pills were dispensed or not dispensed from the package. Policies may control who has access to notifications generated by the pill tray apparatus.

In some embodiments, as noted above, the electrical traces may be applied to pages in a magazine or book. For example, the electrical traces may be applied along the spine of a magazine or book. A battery and microcontroller may also be embedded in the spine, along with a transmitter. As the magazine, book or letter is opened, traces are moved and/or broken and the electrical conductivity of the traces changes. These changes may be tracked, and may further include an indication of each page that was opened, when it was opened, where it was opened, and who purchased the magazine (if it was sent to a subscriber, or if the identity of the purchaser is known from a credit card transaction, for example). In a similar vein, the electrical traces 108 of FIG. 1 may be applied to an envelope seal, to a package, to a box or to any other type of container. Indeed, the apparatus 100 of FIG. 1 may be used to track usage of all kinds of devices.

FIG. 3C illustrates an embodiment in which an electronic display 302 displays information related to the user 303. The display itself may be a liquid crystal display (LCD), electrophoretic display or other type of electronic display. The display indicates, among other things, whether the user has taken their medication 304. Indicators in the display (e.g. 304) may shown whether the user has complied with their prescription that day. If not, a further indication may be provided on the display, such as a colored light, to remind the user the current state of their compliance that day. The display may show the user's name, the medication they are taking (i.e. the medication in the case 301), a battery level and other data.

For example, the display 302 may show dynamic changes in the user's health record (e.g. an electronic health record (EHR)). If a doctor notes a change in the patient's condition and makes a change to his or her medication, the display 302 can be updated to show new dosage information, or changes to how the prescribed drug is to be administered. The enclosure or dock 301 may have buttons 305 and 306 that allow users to interact with internal or external applications. For instance, point of care questions can be asked to a person using the dock, and the user can respond using button 305 to indicate a yes answer or button 306 to indicate a no answer. Answers to such questions may provide additional insight to the doctor or nurse that may cause the medication dosage or method of administering the drug to be changed.

For example, some drugs may have negative side effects. The display on the dock 301 may present a question to the patient asking if they are experiencing a specific negative side effect. If yes, the doctor may take certain actions with respect to the patient's prescription. Other buttons or forms of interaction may, of course, be provided on the dock. For instance, the display 302 may be a touchscreen, or may allow voice or video interaction with a doctor using a built-in camera and microphone. Data provided through the touchscreen, buttons or other interfaces may be transmitted using the transceiver of the device.

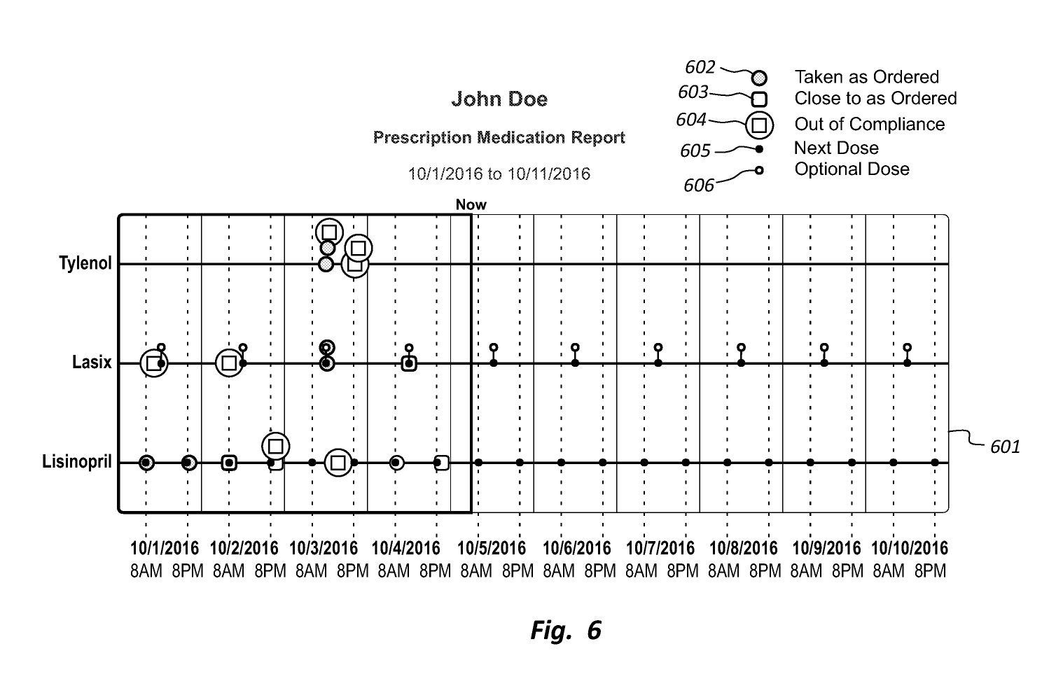

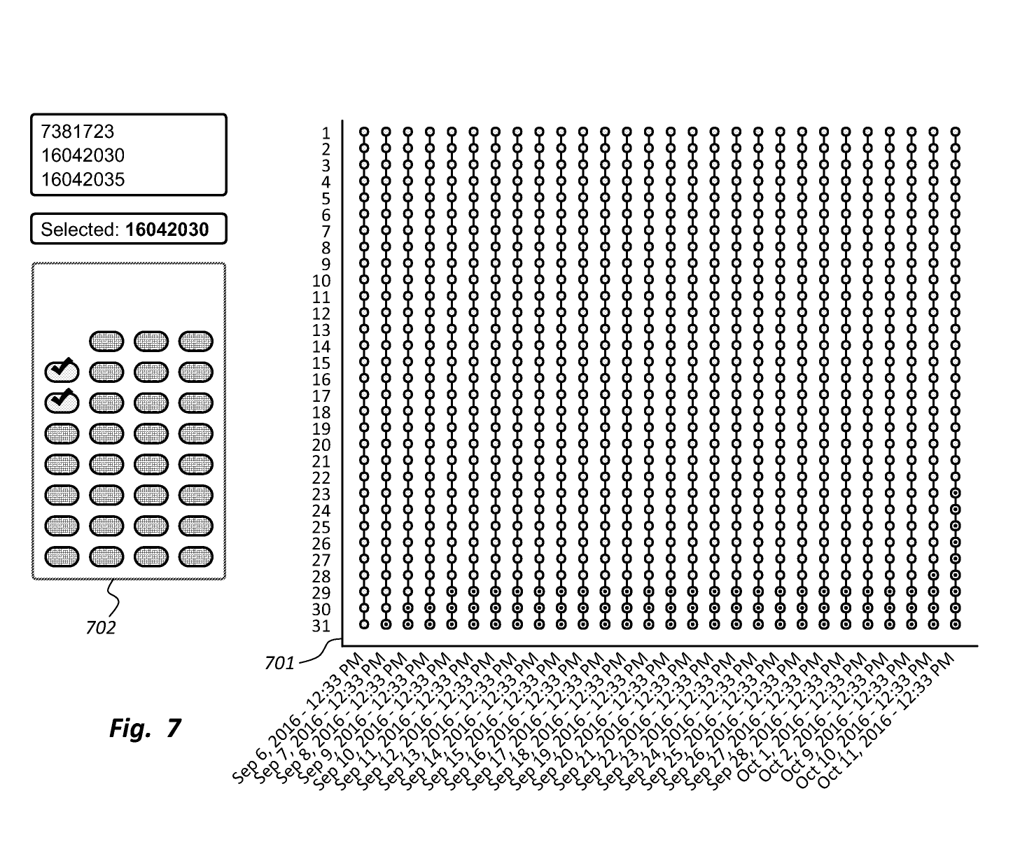

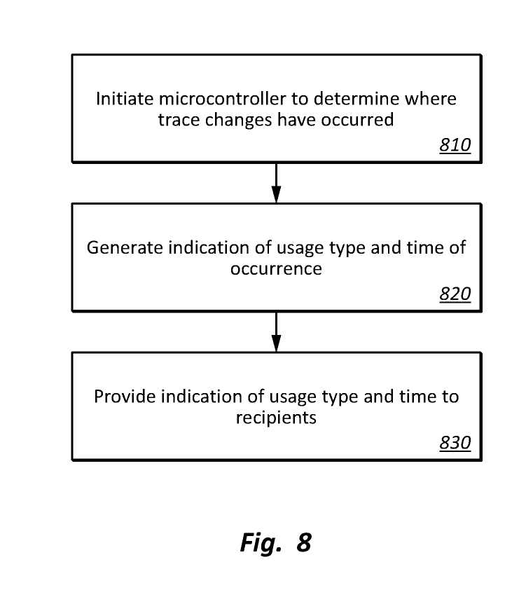

This data may also be transmitted to the user's smartphone and/or to other user's devices such as the doctors' or nurses' devices. The information may be sent in the form of charts, such as those shown in FIGS. 6 and 7. These charts will be discussed further below with regard to method 800 of FIG. 8.

The charts showing a history of pill usage may be transmitted to many different recipients including doctors, nurses, caregivers, hospitals, family members, or other parties of interest. The indication of usage may further include an indication of current geographic coordinates for the sheet of capsules. Thus, the information provided by the sheet of pills may include an indication of which pills were dispensed, when each capsule was opened, where it was opened, a unique identifier for the sheet. Other information may of course be included in the indication of usage, and may be programmed into the microcontroller as needed.

The microprocessor of the apparatus may be configured to send out a signal at a periodic basis to determine which capsules have been opened. The signal may be sent continuously, or periodically, and may be sent through each trace, or only through a select subset of traces (in order to conserve battery power). Signals that return to the microcontroller are assumed to travel through a trace that is still intact. From the received signal, the microcontroller infers that the pill in that capsule has not yet been dispensed. If the microcontroller receives no signal from a particular trace, the microcontroller infers that the pill in that capsule has been dispensed and notes such activity.

Once it has been determine that a change has occurred, the microprocessor provides an indication of which capsules have been opened to the transmitter (e.g. a WiFi radio, a Bluetooth radio, a near-field communication (NFC) radio, a GPS radio or some other type of transmitter or transceiver. The transmitter transmits the indication of opened capsules to one or more specified recipients including healthcare professional or healthcare organizations or insurance companies. The microprocessor provides an indication of when the opened capsules were opened to the transmitter, along with an indication of where the package was when each capsule was opened, and where the package is currently. The microprocessor may further provide a unique identifier for the apparatus to the recipients.

Turning now to FIG. 8, a method 800 is provided for tracking usage of an item, whether the item be a letter, a magazine, a book, a box, a legal document or a package of pharmaceuticals. The method includes initiating a microcontroller (e.g. 102 in FIG. 1) that is configured to send a periodic signal over electrical traces 108 that are distributed over the item to determine whether a change in electrical throughput has occurred in the traces (810). Upon determining that a change in electrical throughput has occurred, the microcontroller 102 generates an indication 110 of the type of usage 111 that occurred and the time 112 it occurred (820). This indication is then transmitted or otherwise provided to various recipients including user 115 (830). The indication may be additionally stored in database 116.

Determining that a change in electrical throughput has occurred in the trace 108 may include determining that electrical conductivity in the trace has changed beyond a threshold amount. Each time a trackable item is created, and traces 108 are distributed thereon, the signal generator 103 of the microcontroller 102 may send out an initializing signal to determine a reference basis for each trace area. Whether there is only one trace area, or whether there are many, the microcontroller 102 will identify the return signal from each trace area to determine whether there is a change in the level of electrical conductance (i.e. a change in the strength of the signal returning to the microcontroller 102). If the trace area no longer conducts electricity, the trace area will register as an open circuit, and the microcontroller will determine that a status change has happened. That status change may indicate that a pill has been punched, a book has been opened, a legal document has been accessed from inside an envelope, etc. This status change may be communicated to one or more users 115.

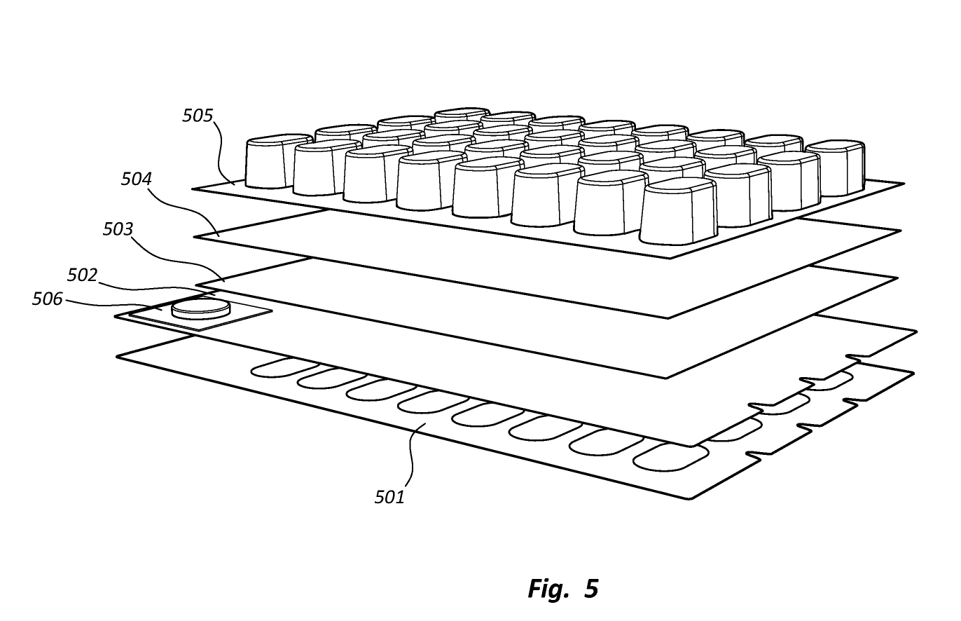

In some cases, determining that a change in electrical throughput has occurred in the trace includes determining that at least one of the electrical traces has been severed. This may occur when a pill has been punched through its capsule container. Alternatively, determining that a change in electrical throughput has occurred in the trace may include determining that voltage has changed across at least one of the electrical traces 108, or that a change in resistance has occurred. Such voltage or resistance changes may not include a complete loss of signal, but a reduction in signal. FIG. 5 illustrates an embodiment that shows various layers that may be used to create a pill tray. Changes to any of these layers may cause changes in voltage or resistance across a trace.

The pill tray of FIG. 5 shows an embodiment where electrical traces may be applied to a sheet of capsules designed to hold controlled substances such as pharmaceutical pills. The first layer 501 may be a supportive, structural layer made out of cardboard or other material that can provide rigidity and form. The structural layer 501 may include cutouts for pills or other items. The structural layer 501 may be covered with a layer 502 of aluminum foil and paper with conductive ink traces. The traces may thus be printed in ink, or may be electrical traces. Layer 502 may include the battery, microcontroller, transmitter and/or other electrical components. Layer 503 is an adhesive layer that binds layer 502 to layer 504. Layer 504 is a peel-away wax paper layer, and layer 505 is the layer that includes the plastic blisters or capsules that contain the pills. It should be noted, of course, that while certain materials have been listed above, other adhesives, separation elements, structural elements or conductive elements may be used.

As users push on the blisters on layer 505, the foil strip traces are breached through the dispensing of the pill. The electrical conductivity to that capsule is changed, and the change can be tracked by the microcontroller. The microcontroller 102 can track these changes over time and can report these changes to various entities, including to a software application on the user's phone. The software application may provide an indication of the type of usage that occurred for a sheet of capsules such as the one in FIG. 5 may include generating an indication of which capsules were opened and when they were opened. The sheet of capsules may be identified by a unique identifier such as a numeric ID, a quick response (QR) code, a bar code or other identifier. This unique identifier may be transmitted along with the indication of usage.

The indication generator 104 of the microcontroller 102 may be configured to provide the indications of usage type 111, time 111, location data 114 and the pill tray identifier 113 to doctors, nurses, family members and/or to a mobile device of the user. The users' mobile devices may include software applications configured to interpret the data and generate usage charts such as those shown in FIGS. 6 and 7. For example, FIG. 6 illustrates a prescription medication report 601 for a period of 10 days from Oct. 1, 2016, to Oct. 10, 2016. This prescription medication report 601 includes multiple types of data for days in the past and for days in the future. For instance, chart 601 indicates, for three different drugs, whether the patient took the drugs on the specified day and time as ordered (602), took the drugs close to the time ordered (603), or took the drugs out of compliance (604) (i.e. not as directed). The chart 601 also indicates, for days in the future, when the next dose is due (605) for each drug, and when optional doses are due (606). Other data may be shown or omitted as desired by the user. Similar charts may be provided to doctors, nurses or family members.

FIG. 7 illustrates a chart 701 that shows usage for each of the 31 capsules in visual 702. Indeed, chart 701 shows, on the X-axis, the date and time each trace area (i.e. each capsule) was accessed to determine usage. Visual 702 shows that two of the capsules have been punched, and chart 701 shows when they were punched. Thus, a user can easily see when pills were taken (or at least punched out of their container) in 701, and see which containers were punched in visual 702. Other information may be provided such as an identifier for the tray of pills, patient data or other information. The chart may be expanded to further show the location of the pill tray when each pill was punched. For instance, the pill tray may have a GPS radio or may use WiFi or other radio signals to determine its geographic coordinates. These geographic coordinates may then be provided on the chart 701 or as a separate indication.

In one embodiment, an apparatus for tracking usage of controlled substances is provided. The apparatus includes a battery, a microprocessor, a transmitter, and multiple capsules for storing the controlled substances. Each capsule has an electrical trace extending through at least some of the capsule. That trace may be printed on the capsule using electrically-conductive ink. The microprocessor of the apparatus determines, using the electrical traces, which capsules have been opened by identifying which traces have been broken. The microprocessor sends out a signal or pulse at a periodic basis to determine which traces have been severed, indicating which capsules have been opened. The microprocessor then provides an indication of which capsules have been opened to the transmitter, along with potentially other information identifying when and where the capsules were opened. This indication is then transmitted to various recipients.

In another embodiment, a system for tracking usage of controlled substances is provided. The system includes an enclosure (e.g. 301 of FIG. 3) configured to provide protection and access to a storage apparatus 302 that has controlled substances contained therein. The storage apparatus can be inserted into the enclosure, where electrical contact pads connect the storage apparatus to a microcontroller contained in the enclosure. The enclosure may have many different components including a battery, a display, a transmitter, and a microcontroller configured to control operation of the display and to further analyze trace signals to determine usage of the controlled substances.

The storage apparatus which contains the controlled substances, includes capsules for storing the controlled substances. Each capsule has an electrical trace extending through or winding over the capsule. The microprocessor of the enclosure is configured to determine, using the electrical traces of the storage apparatus, which capsules have been opened according to return signals indicating which traces have been broken. The microprocessor may provide a unique identifier for the apparatus to the recipients, identifying the specific pill tray and/or the medications contained therein. The transmitter of the enclosure may be configured to synch with other electronic devices associated with a user to provide data consumption data, location data, and other specified data. The synch may occur over Bluetooth, WiFi or other wireless communication means.

Thus, in this manner, two different general types of apparatus may be provided: a first embodiment in which a battery, microprocessor and transmitter are attached to the pill tray, which has printed labels and no display. This version may be cheaply produced and may, in some cases, be disposable. The second embodiment may include an enclosure or dock that has the microcontroller, display, battery, and transmitter. With this version, the pill sheet would be disposable, while the dock would be kept and used repeatedly. Both versions allow patients and caregivers to track drug usage and compliance, thereby ensuring that prescriptions are followed and outcomes are improved. And, if prescriptions are not followed, information is available to the doctor showing why improvements were not seen as expected.

Accordingly, methods and apparatuses are provided which allow users to track the usage of an item. The methods and apparatuses described herein may be applied in many different ways and in many different industries. Indeed, the pill capsule application shown in FIGS. 2A-5 is merely one embodiment among many different embodiments including implementations in books, magazines, envelopes, bottles or other containers.

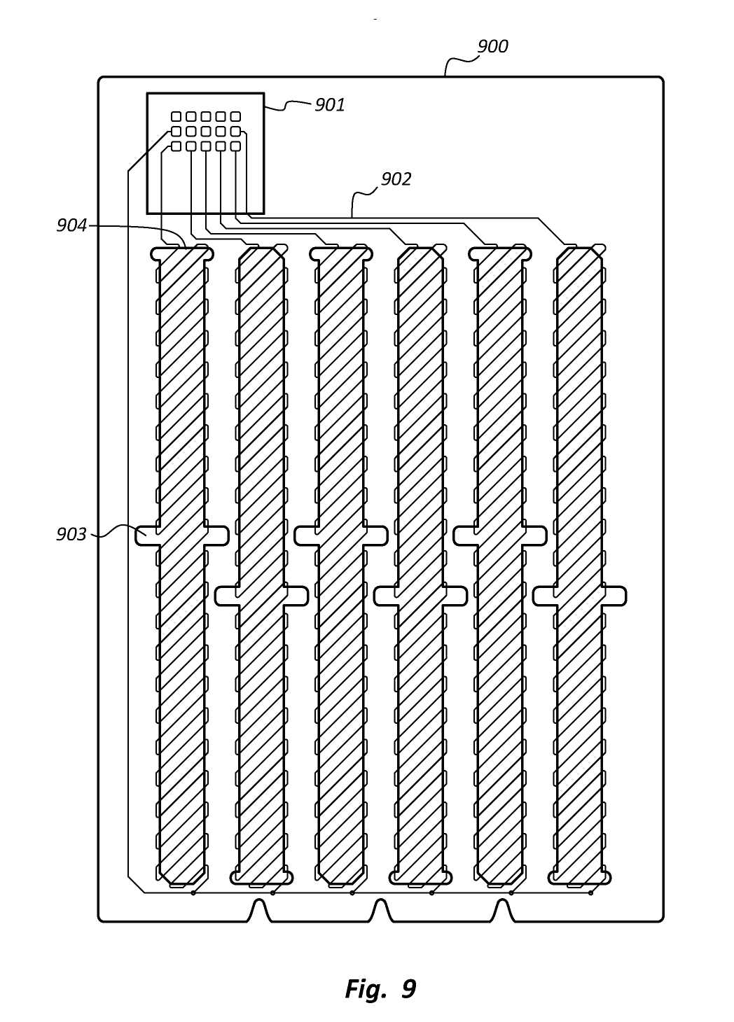

Indeed, as shown in FIG. 9, an apparatus 900 may be provided for use with syringes. The apparatus 900 includes contact pads 901 which may align with those in the dock 301 of FIG. 3, or may facilitate connection with a built-in microcontroller (e.g. 206 of FIG. 2B). The apparatus 900 includes capsules 904 that hold syringes 903, where each capsule is overlaid with traces 902. These traces 902 function in a manner similar to that described above with regard to the pill capsules. When a syringe 903 is removed from the apparatus 900, the overlaid traces 902 will be disturbed or broken, and a change in electrical conductivity will occur. As each syringe is separately covered in traces, each can be separately tracked as to the time and place where the syringe is removed.

Moreover, each instance of the apparatus 900 may include its own unique identifier so that the provider of the apparatus (e.g. a doctor, a pharmacy, a hospital, etc.) can know which patient the syringes were provided to, and when each was accessed. As with the pill capsules, this can help prevent overdoses, by providing the healthcare provider with information regarding when each capsule was punctured. If all (or a substantial number) of the capsules were opened within a very short timeframe, then the healthcare provider will be alerted that misuse has likely occurred. Moreover, if the capsules are not punctured at all, or are punctured at a rate much lower than expected, the healthcare provider can be alerted that the patient is not adhering to their prescription. The embodiments herein thus allow healthcare providers to be fully up-to-date regarding a patient's usage of the pills or syringes (or other devices) and can make future decisions based on that information.

Other embodiments may also be provided for medications that are distributed in multi-packs or bubble packs. These medications are often distributed in small sealed packages that are linked together on a roll. The packages may be print labeled with information describing the medications inside, and the days and/or times the medications are to be taken. For example, a roll of medications provided in this manner may include a week's worth of medications for a user, with an AM pack for the morning with three different medications, each listed with the dosage that is included in the bubble pack, and a PM pack for the evening with perhaps different medications, each with its corresponding identifier and dosage. These bubble packs are convenient for patients, as they include exactly those pills needed for that timeframe, and are labeled as such using ink that can be printed on plastic.

Embodiments herein can implement such bubble packs or multi-packs. Electronically conductive ink may be printed on front or the back of the bubble packs. A clip or dock (e.g. dock 301) or other device configured to apply an electrical signal may then be attached to at least a portion of the bubble pack. Once the electrical signal is applied, the return signal may be measured, and then a microcontroller can determine a change in electrical conductivity. Additionally or alternatively, the clip or dock may be configured to measure the resistance of the electrical traces. As each medication pack is removed from the roll of bubble packs, the resistance through the electronic traces will decrease by a specified amount. Thus, in this manner, the embodiments and principles described above with regard to pill and syringe packages can be applied to bubble packs or multi-packs using printed ink traces.

Furthermore, the concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method for tracking usage of an item, the method comprising:
initiating a microcontroller that is configured to send a periodic signal over one or more electrical traces that are distributed over an item to determine whether a change in electrical throughput has occurred in the trace;
upon determining that a change in electrical throughput has occurred, generating an indication of the type of usage that occurred and the time it occurred; and
providing the indication of type of usage and the time of occurrence to one or more specified recipients.

2. The method of claim 1, wherein determining that a change in electrical throughput has occurred in the trace comprises determining that electrical conductivity in the trace has changed beyond a threshold amount.

3. The method of claim 1, wherein determining that a change in electrical throughput has occurred in the trace comprises determining that at least one of the electrical traces has been severed.

4. The method of claim 1, wherein determining that a change in electrical throughput has occurred in the trace comprises determining that voltage has changed across at least one of the electrical traces.

5. The method of claim 1, wherein the one or more electrical traces are applied to one or more pages in a magazine or book.

6. The method of claim 1, wherein the one or more electrical traces are applied to an envelope seal, to a package or to a box.

7. The method of claim 1, wherein the one or more electrical traces are applied to a sheet of one or more capsules designed to hold controlled substances.

8. The method of claim 7, wherein generating an indication of the type of usage that occurred comprises generating an indication of which capsules were opened and when they were opened.

9. The method of claim 7, wherein the sheet of capsules is identified by a unique identifier, the unique identifier being provided along with the indication of usage.

10. The method of claim 7, wherein the indication of usage provided to the one or more recipients further includes an indication of geographic coordinates for the sheet of capsules at the time the indication is generated.

11. An apparatus for tracking usage of controlled substances, the apparatus comprising:
a battery;
one or more microprocessors;
a transmitter; and
a plurality of capsules for storing the controlled substances,
wherein each capsule has an electrical trace extending through at least a portion of the capsule; and
wherein the microprocessor is configured to determine, using the electrical traces, which capsules have been opened by identifying which traces have been broken.

12. The apparatus of claim 11, wherein the trace is a printed trace printed on at least a portion of the apparatus.

13. The apparatus of claim 11, wherein the microprocessor sends out a signal at a periodic basis to determine which traces have been severed, indicating which capsules have been opened.

14. The apparatus of claim 11, wherein the microprocessor provides an indication of which capsules have been opened to the transmitter, which transmits the indication of opened capsules to one or more specified recipients.

15. The apparatus of claim 11, wherein the microprocessor provides an indication of when the opened capsules were opened to the transmitter for transmission to one or more recipients.

16. A system for tracking usage of controlled substances, the system comprising:
an enclosure configured to provide protection and access to a storage apparatus having one or more controlled substances contained therein, the storage apparatus being insertable into the enclosure, the enclosure comprising:
a battery;
a display;
a transmitter; and
a microcontroller configured to control operation of the display and to further analyze trace signals to determine usage of the controlled substances; and
the storage apparatus which contains the one or more controlled substances, the storage apparatus comprising a plurality of capsules for storing the controlled substances, each capsule having an electrical trace extending through at least a portion of the capsule,
wherein the microprocessor of the enclosure is configured to determine, using the electrical traces of the storage apparatus, which capsules have been opened by identifying which traces have been broken.

17. The system of claim 16, wherein the microprocessor provides a unique identifier for the apparatus to the one or more recipients.

18. The system of claim 16, wherein the transmitter of the enclosure is configured to synch with one or more electronic devices associated with a user to provide data consumption data, location data, and other specified data.

19. The system of claim 16, wherein the display is configured to display information regarding usage of the controlled substances or information regarding updates to dosage or changes in how the controlled substances are to be administered.

20. The system of claim 16, wherein the microcontroller of the enclosure is configured to generate a report based on the determined usage of the controlled substances.
